(19) United States
(12) Patent Application Publication
(10) Pub. No.: US 2026/0301640 A1
(43) Pub. Date: Oct. 1, 2026

(54) DISPLAY DEVICE AND METHOD OF DRIVING DISPLAY DEVICE

(71) Applicant: LG Display Co., Ltd., Seoul (KR)

(72) Inventors: Seokmin CHOI, Paju-si (KR); MooKyoung HONG, Paju-si (KR)

(21) Appl. No.: 19/434,961

(22) Filed: Dec. 29, 2025

(30) Foreign Application Priority Data
Mar. 31, 2025 (KR) 10-2025-0041037

(51) Int. Cl. G09G 3/20; G09G 3/3233

(52) U.S. Cl. CPC G09G 3/2092; G09G 3/3233; G09G 2300/0819; G09G 2300/0842; G09G 2310/08; G09G 2320/0247; G09G 2340/0435

(57) ABSTRACT

A display device and a method of driving a display device, where the display device includes a display panel which is driven at a driving frequency and on which pixels are disposed, a gate driving circuit configured to apply a scan signal to the pixels, a data driving circuit configured to convert image data to generate a data voltage and apply the data voltage to the pixels, and a timing control circuit configured to receive an image signal from an external source, convert the image signal, and output the image data to the data driving circuit.

### CROSS REFERENCE TO RELATED APPLICATION

Pursuant to 35 U.S.C. § 119(a), this application claims the benefit of an earlier filing date and right of priority to Korean Patent Application No. 10-2025-0041037, filed Mar. 31, 2025, the entire contents of which is incorporated herein for all purposes by this reference.

### TECHNICAL FIELD

The present disclosure relates to a display device and a method of driving a display device.

### BACKGROUND

As information society develops, demand for display devices for displaying images are increasing, and various types of display devices such as liquid crystal display (LCD) devices and organic light emitting diode (OLED) display devices are utilized.

Images displayed on a display device may be still images or moving images, and the moving image may include various types such as sports images, game images, and movies.

### SUMMARY

According to one implementation, there is provided a display device including a display panel which is driven at a driving frequency and on which pixels are disposed, a gate driving circuit configured to apply a scan signal to the pixels, a data driving circuit configured to convert image data to generate a data voltage and apply the data voltage to the pixels, and a timing control circuit configured to receive an image signal from an external source, convert the image signal, and output the image data to the data driving circuit.

The timing control circuit compensates for a luminance of the image data based on the driving frequency and an original luminance value of the image signal to generate compensated image data and provides the compensated image data to the data driving circuit.

The driving frequency may vary depending on a variable refresh rate mode, and in the variable refresh rate mode, the pixels may be driven on a frame-by-frame basis.

The frame may include an active period in which the data voltage is programmed in the pixels, and a blank period in which the programming of the data voltage is omitted and a length of the blank period varies depending on the driving frequency.

The timing control circuit may include an image processor configured to receive the image signal and convert the image signal to generate the image data, and a memory configured to store a luminance compensation value corresponding to the driving frequency and the original luminance value of the image signal.

The image processor may determine the luminance compensation value corresponding to the driving frequency and the original luminance value of the image signal from the memory and apply the selected luminance compensation value to the image data to generate the compensated image data.

The luminance compensation value may be configured to decrease nonlinearly as the driving frequency decreases, and decrease nonlinearly as the original luminance value decreases.

The memory may include a first look-up table in which a first luminance compensation value corresponding to the driving frequency is defined, and a second look-up table in which a second luminance compensation value corresponding to the original luminance value is defined.

The image processor may generate the image data using the first luminance compensation value acquired from the first look-up table and the second luminance compensation value acquired from the second look-up table.

The memory may store a look-up table including a luminance compensation value defined in a three-dimensional graph form using the driving frequency and the original luminance value as variables.

The image processor may generate the image data using the luminance compensation value acquired from the look-up table.

The luminance compensation value may be defined as a first luminance compensation value when the driving frequency or the original luminance value is less than a first threshold value, and a second luminance compensation value when the driving frequency or the original luminance value is greater than or equal to a second threshold value that is greater than the first threshold value.

The luminance compensation value may be defined to be linearly proportional to the driving frequency or the original luminance value between the first luminance compensation value and the second luminance compensation value when the driving frequency or the original luminance value is greater than the first threshold value and smaller than the second threshold value.

The luminance compensation value may be a value defining an amount of increase or decrease in the luminance and may have a value between 0 and 1.

The image processor may determine the luminance compensation value based on a driving frequency of a previous frame and apply the selected luminance compensation value to image data of a current frame to generate the compensated image data of the current frame.

The image processor may compensate for the luminance of the image data in incremental steps during one or more frames from the current frame.

The image processor may generate the compensated image data for the image data of a first frame based on a first luminance compensation value, generate the compensated image data for the image data of a second frame subsequent to the first frame based on a second luminance compensation value according to the driving frequency and the original luminance value, and generate the compensated image data during at least one of the first frame and the second frame based on a luminance compensation value between the first luminance compensation value and the second luminance compensation value.

According to one implementation, there is provided a display device including a display panel which is driven at a driving frequency and on which pixels are disposed, a gate driving circuit configured to apply a scan signal to the pixels, a data driving circuit configured to convert image data to generate a data voltage and apply the data voltage to the pixels, and a timing control circuit configured to receive an image signal from an external source, convert the image signal, and output the image data to the data driving circuit.

The timing control circuit compensates for the image data using a luminance compensation value determined based on the driving frequency and an original luminance value of the image signal and provides the compensated image data to the data driving circuit.

The luminance compensation value may be defined to decrease when at least one of the driving frequency and the original luminance value decreases.

The timing control circuit may select the luminance compensation value based on a driving frequency of a previous frame and apply the selected luminance compensation value to image data of a current frame to generate the compensated image data of the current frame.

The timing control circuit may compensate for the luminance of the image data step by step during one or more frames from the current frame.

According to one implementation, there is provided a method of driving a display device, including generating, by the timing control circuit, compensated image data for the image data of a first frame based on a first luminance compensation value during the first frame, and generating, by the timing control circuit, compensated image data for the image data based on a second luminance compensation value corresponding to the driving frequency and the original luminance value of the image signal when at least one of the driving frequency and the original luminance value of the image signal changes in a second frame subsequent to the first frame

The first luminance compensation value and the second luminance compensation value may be defined to decrease when at least one of the driving frequency and the original luminance value decreases.

The generating of the compensated image data for the image data of the second frame may include generating the compensated image data for the image data of a third frame subsequent to the second frame based on the driving frequency of the second frame and the original luminance value.

The method may further include generating compensated image data of the image data based on a third luminance compensation value between the first luminance compensation value and the second luminance compensation value during at least one of the first frame and the second frame.

The third luminance compensation value may gradually increase or decrease from the first luminance compensation value to the second luminance compensation value during the at least one frame.

### BRIEF DESCRIPTION OF THE DRAWINGS

FIG. 1 is a block diagram illustrating an example of a configuration of a display device according to one implementation.

FIG. 2 is a circuit diagram of the pixel according to one implementation.

FIG. 3 is a view illustrating an example of a method of driving a pixel according to one implementation.

FIG. 4 is a view illustrating an example of a variable refresh rate driving method according to one implementation.

FIG. 5 is a view illustrating an example of a difference in integrated luminance according to refresh rates.

FIG. 6 is a view illustrating an example of a change in perceived luminance according to changes in the refresh rate.

FIG. 7 is a view illustrating an example of increases and decreases in perceived luminance according to luminance and refresh rates.

FIG. 8 is a block diagram illustrating an example of a configuration of a timing controller according to one implementation.

FIGS. 9 to 11 are views illustrating an example of luminance compensation values based on luminance and refresh rates according to one implementation.

FIG. 12 is a view illustrating an example of luminance compensation values based on luminance and refresh rates according to another implementation.

FIG. 13 is a view illustrating an example of input and output signals of an image processor according to one implementation.

FIG. 14 is a view illustrating an example of input and output signals of an image processor according to another implementation.

### DETAILED DESCRIPTION

A display device can be driven in a variable refresh rate (VRR) mode in which a driving frequency varies depending on the type of an image. This can help reduce power consumption and extend the lifetime of the display device.

However, when the variable refresh rate mode is applied to drive pixels at various refresh rates, a luminance difference can occur between the pixels due to different refresh rates. This can result in problems of quality degradation, such as image warpage or flicker.

Implementations of the present disclosure can provide a display device that can compensate for luminance based on a refresh rate and an original luminance value of image data in a variable refresh rate mode, and a method of driving a display device.

Implementations can provide a display device that can reduce luminance when a refresh rate decreases, and a method of driving a display device.

Implementations can provide a display device that can reduce luminance when an original luminance value of image data decreases, and a method of driving a display device.

Implementations can provide a display device that can pre-store a luminance compensation value determined in response to a refresh rate and an original luminance value in the form of a look-up table, and a method of driving a display device.

Implementations can provide a display device that can compensate luminance step by step over a plurality of frames when luminance changes rapidly between adjacent frames due to luminance compensation, and a method of driving a display device.

Hereinafter, various examples of implementations will be described with reference to the accompanying drawings. In the specification, when a certain component (or an area, a layer, a portion, etc.) is described as “on,” “connected,” or “coupled to” another component, it means that the certain component may be directly connected/coupled to another component or still another component may be disposed therebetween.

The same reference numerals indicate the same components. In addition, in the drawings, thicknesses, proportions, and dimensions of components are exaggerated for effective description of technical contents. The term “and/or” includes all one or more combinations that may be defined by the associated configurations.

Terms such as “first,” “second,” and the like may be used to describe various components, but the components are not limited by the terms. The terms are used only for the purpose of distinguishing one component from another. For example, a first component may be referred to as a second component, and similarly, the second component may also be referred to as the first component without departing from the scopes of the implementations. The singular includes the plural unless the context clearly dictates otherwise.

Terms such as “under,” “at a lower side,” “above,” and “at an upper side” are used to describe the relationship between the components illustrated in the drawings. The terms are relative concepts and are described with respect to directions marked in the drawings.

It should be understood that term such as “includes” or “has” is intended to specify the presence of features, numbers, steps, operations, components, parts, or a combination thereof described in the specification and does not preclude the presence or addition possibility of one or more other features, numbers, steps, operations, components, parts, or combinations thereof in advance.

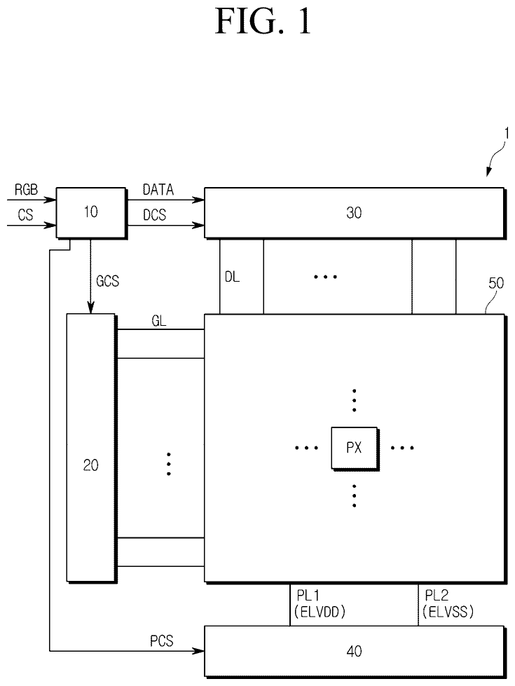

FIG. 1 is a block diagram showing a display device according to one implementation.

Referring to FIG. 1, a display device 1 includes a timing controller 10, a gate driver 20, a data driver 30, a power supply unit 40, and a display panel 50.

The timing controller 10 may include or be coupled to various processors, such as a microprocessor, a mobile processor, an application processor, and the like according to a device to be mounted.

The timing controller 10 may receive image signals RGB and control signals CS from an external host system or the like. The image signals RGB may include a plurality of grayscale data. The control signals CS may include, for example, a horizontal synchronization signal, a vertical synchronization signal, and a main clock signal.

The timing controller 10 may process the image signals RGB and the control signals CS according to operating conditions of the display panel 50 to generate and output image data DATA, a gate driving control signal GCS, a data driving control signal DCS, and a power supply control signal PCS.

The gate driver 20 may include circuitry to generate scan signals based on the gate driving control signal GCS output from the timing controller 10. The gate driver 20 may provide the generated gate signals to pixels PX through a plurality of gate lines GL.

In one implementation, one pixel PX may be formed to receive a plurality of scan signals with different waveforms. In the implementation, the gate driver 20 may provide the plurality of gate signals to the pixels PX through the corresponding gate lines GL.

The gate driver 20 may be formed in a form of a gate in panel mounted on the display panel 50. The gate driver 20 may be disposed at one side of the display panel 50 or both sides (e.g., left and right sides) of the display panel 50. According to a driving method, a panel design method, and the like, the gate driver 20 may be disposed at both sides (e.g., left and right sides) of the display panel 50 or connected to two or more of four side surfaces of the display panel 50.

The data driver 30 may include circuitry to generate data signals based on the image data DATA and the data driving control signal DCS that are output from the timing controller 10. The data driver 30 may provide the generated data signals to the pixels PX through a plurality of data lines DL.

The power supply unit 40 may generate a high potential driving voltage ELVDD and a low potential driving voltage ELVSS, which will be provided to the display panel 50 based on the power supply control signal PCS. The power supply unit 40 may provide the generated driving voltages ELVDD and ELVSS to the pixels PX through corresponding voltage lines PL1 and PL2. In addition, the power supply unit 40 may further generate a reference voltage and the like required for driving the pixels PX and provide the reference voltage and the like to the pixels PX through the corresponding voltage lines.

The display panel 50 may be implemented as a non-transmissive display panel or a transmissive display panel. The transmissive display panel may be applied to a transparent display device in which images are displayed on a screen and a real object in the background is visible.

The display panel 50 may be manufactured as a flexible display panel. The flexible display panel may be implemented as an organic light emitting diode (OLED) panel using a plastic substrate.

A plurality of pixels PX (or referred to as sub-pixels) are disposed on the display panel 50. For example, the pixels PX may be arranged in a form of a matrix on the display panel 50. Pixels PX disposed in one pixel row are connected to the same gate line GL, and pixels PX disposed in one pixel column are connected to the same data line DL. The pixels PX may emit light with luminance corresponding to the gate signal and data signal supplied through the gate lines GL and the data lines DL.

Each pixel PX may include a light-emitting element and a driving circuitry for driving the light-emitting element. The light-emitting element included in the pixel PX may display one of red, green, and blue.

In another implementation, the light-emitting element may display one of cyan, magenta, and yellow. In various implementations, the light-emitting element may display one of red, green, blue, and white.

In one implementation, a touch sensor may be further disposed on the display panel 50. A touch input may be sensed using touch sensors or sensed through the pixels PX. The touch sensors are on-cell type or add-on type touch sensors and may be implemented as an in-cell type touch sensors disposed on the display panel 50 or embedded into the display panel 50.

The timing controller 10, the gate driver 20, the data driver 30, and the power supply unit 40 may each be formed as a separate IC or at least partially integrated IC.

In one implementation, the display device 1 may be driven in a variable refresh rate mode in which a driving frequency may vary. For example, the display device 1 may be driven at a refresh rate that is higher or lower than a predetermined reference refresh rate.

When the display device 1 is driven at a rate lower than the reference refresh rate, it can be referred to as “low-frequency driving,” and when the display device 1 is driven at a rate higher than the reference refresh rate, it can be referred to as “high-frequency driving.” The refresh rate may be determined according to the type of image being displayed or the like, but is not limited thereto.

The timing controller 10 may generate control signals so that the pixels PX may be driven at various refresh rates. For example, the timing controller 10 may change the refresh rate by changing a frequency of the clock signal included in the control signals, adjusting the timing of the horizontal synchronization signal or the vertical synchronization signal, or driving the gate driver 20 in a mask manner.

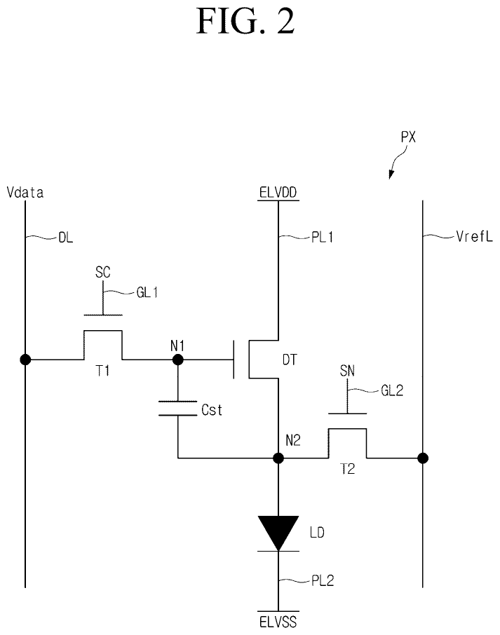

FIG. 2 is a circuit diagram of the pixel according to one implementation.

Referring to FIG. 2, the pixel PX according to one implementation may include a driving transistor DT, a light-emitting element LD connected to the driving transistor DT, and a control circuit for controlling the amount of driving current to be applied to the light-emitting element LD through the driving transistor DT. For example, the control circuit may include transistors T1 and T2 and a storage capacitor Cst.

A first electrode of the driving transistor DT is formed to receive the high potential driving voltage ELVDD (connected to the high potential driving voltage line PL1), and a second electrode thereof is connected to the light-emitting element LD via a second node N2. A gate electrode of the driving transistor DT is connected to the data line DL via the first node N1. The driving transistor DT may be turned on according to a difference in voltages applied to the first node N1 and the second node N2 to control the amount of driving current flowing to the light-emitting element LD.

A first electrode of a first transistor T1 is connected to the data line DL, and a second electrode thereof is connected to the gate electrode of the driving transistor DT via the first node N1. A gate electrode of the first transistor T1 may be connected to a first gate line GL1 to receive a first gate signal. The first gate signal is a scan signal SC and may be a control signal applied to program a data voltage Vdata in the pixel PX.

The first transistor T1 may be turned on according to the scan signal SC applied to the first gate line GL1 to transmit the data voltage Vdata applied to the data line DL to the first node N1. The first transistor T1 may be referred to as “switching transistor.”

A first electrode of a second transistor T2 is connected to a reference voltage line VrefL, and a second electrode thereof is connected to the second node N2. A gate electrode of the second transistor T2 may be connected to a second gate line GL2 to receive a second gate signal. The second gate signal may be a sensing signal SN and may be a control signal applied to apply a reference voltage to the pixel PX or sense the electrical characteristics of the pixel PX.

The second transistor T2 may be turned on in response to the sensing signal SN applied to the second gate line GL2 to electrically connect the reference voltage line VrefL to the second node N2. When the reference voltage Vref is applied to the reference voltage line VrefL, the reference voltage Vref may be applied to the second node N2 through the turned-on second transistor T2.

When the reference voltage line VrefL is not connected to the reference voltage Vref, the sensing signal (e.g., current, voltage) applied to the second node N2 may flow to the data driver 30 (see FIG. 1) and/or the timing controller 10 (see FIG. 1) through the reference voltage line VrefL.

The transmitted sensing signal may be used to detect the electrical characteristics of the pixel PX. The second transistor T2 may be referred to as an initialization transistor and/or a sensing transistor.

The storage capacitor Cst is connected between the first node N1 and the second node N2. The storage capacitor Cst may store a voltage corresponding to a voltage difference between the first node N1 and the second node N2 and maintain the stored voltage during one frame, thereby stabilizing the voltage of the gate electrode (i.e., the first node N1) of the driving transistor DT.

The light-emitting element LD may have an anode electrode connected to the driving transistor DT via the second node N2 and a cathode electrode connected to a low potential driving voltage ELVSS (connected to the low potential driving voltage line PL2). When the driving transistor DT is turned on, a current path may be formed between the high potential driving voltage ELVDD and the low potential driving voltage ELVSS so that the driving current may flow to the light emitting device LD. The light emitting element LD may emit light with luminance corresponding to the amount of driving current applied.

In the implementation illustrated in FIG. 2, the pixel PX may be formed of oxide semiconductor transistors. The oxide semiconductor transistor includes a gate electrode, a source electrode, and a drain electrode. The oxide semiconductor transistor has an active layer formed of an oxide semiconductor.

Here, the oxide semiconductor may be set to an amorphous or crystalline oxide semiconductor. The oxide semiconductor transistor may be formed as an n-type transistor. The oxide semiconductor transistor may be processed at low temperature and has lower charge mobility than a low temperature poly-silicon (LTPS) transistor. The oxide semiconductor transistor has excellent off-current characteristics.

In another implementation, the pixel PX may be of a hybrid type that further includes an LTPS transistor.

The LTPS transistor includes a gate electrode, a source electrode, and a drain electrode. The LTPS transistor has an active layer formed of polysilicon. The LTPS transistor may be formed of a p-type thin film transistor or an n-type thin film transistor. The LTPS transistor has high electron mobility, and thus has fast driving characteristics.

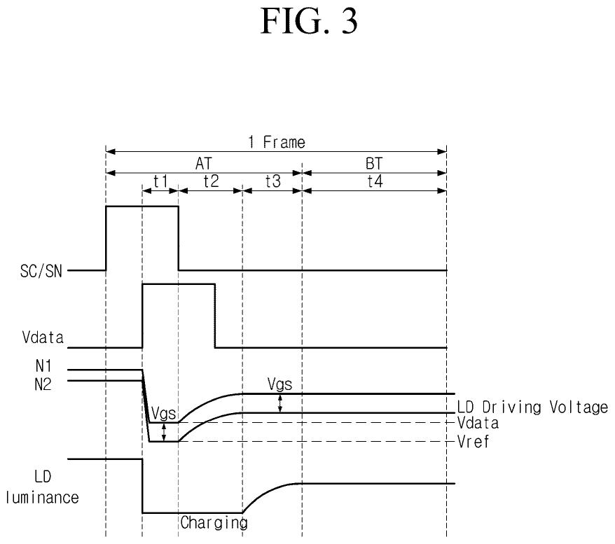

FIG. 3 is a view showing a method of driving the pixel illustrated in FIG. 2.

Referring to FIGS. 2 and 3 together, the pixel PX may be driven on a frame-by-frame basis. One frame may include an active period AT for displaying an image and a blank period BT following the active period.

During the active period AT, the data voltage (Vdata) may be programmed in the pixel PX, and the light-emitting element LD may emit light with luminance corresponding to the data voltage Vdata. In this implementation, the active period AT may be referred to as a refresh time in which the data voltage Vdata is programmed.

The active period AT may include a programming time t1, a boosting time t2, and a light-emitting time t3.

During the programming time t1, the first transistor T1 may be turned on by the scan signal SC at a turn-on level, and the second transistor T2 may be turned on by the sensing signal SN at a turn-on level. During the programming time t1, the reference voltage Vref is applied to the reference voltage line VrefL, and the data voltage Vdata is applied to the data line DL.

Accordingly, the data voltage Vdata may be applied to the first node N1 of the driving transistor DT, and the reference voltage Vref may be applied to the second node N2. For example, during the programming time t1, a gate-source voltage of the driving transistor DT is programmed to a difference voltage between the data voltage Vdata and the reference voltage Vref.

The programmed voltage may be stored in the storage capacitor Cst. In this case, the gate-source voltage is higher than a threshold voltage of the driving transistor DT, and the driving transistor DT may be turned on.

During the boosting time t2, the scan signal SC and the sensing signal SN transition to the turn-off level to turn off the first transistor T1 and the second transistor T2. Then, a driving current may be applied to the second node N2 through the turned-on driving transistor DT. A voltage of the second node N2 may gradually increase due to the driving current.

In this case, a voltage of the first node N1 coupled to the second node N2 by the storage capacitor Cst may increase in response to the voltage increase of the second node N2. Accordingly, the gate-source voltage of the driving transistor DT is maintained at the voltage programmed during the programming time t1.

When a voltage of the second node N2 increases to a driving voltage of the light-emitting element LD, the light-emitting element LD may be turned on during the light-emitting time t3. During the light-emitting time t3, a driving current corresponding to the gate-source voltage of the driving transistor DT may flow to the light-emitting element LD, and the light-emitting element LD may emit light with luminance corresponding to the driving current.

During the blank period BT, the light-emitting element LD may emit light in response to a previously programmed data voltage Vdata. For example, the blank period BT may consist solely of the light-emitting time t4. In this implementation, the blank period BT may be referred to as a skip time or hold time during which programming of the data voltage Vdata is omitted.

In various implementations, a voltage of the anode electrode of the light-emitting element LD may be initialized during the blank period BT, or the degradation of driving elements, such as the driving transistor DT and/or the light-emitting element LD, may be sensed. The degradation may include, for example, a threshold voltage and mobility of the driving transistor DT and a change in the driving voltage of the light-emitting element LD.

In this case, a predetermined compensation voltage corresponding to the degradation may be added to the data voltage Vdata, and the compensated data voltage Vdata may be applied to the pixel PX. In this manner, the mobility, the time-varying threshold voltage Vth, and the like of the pixel PX may be compensated.

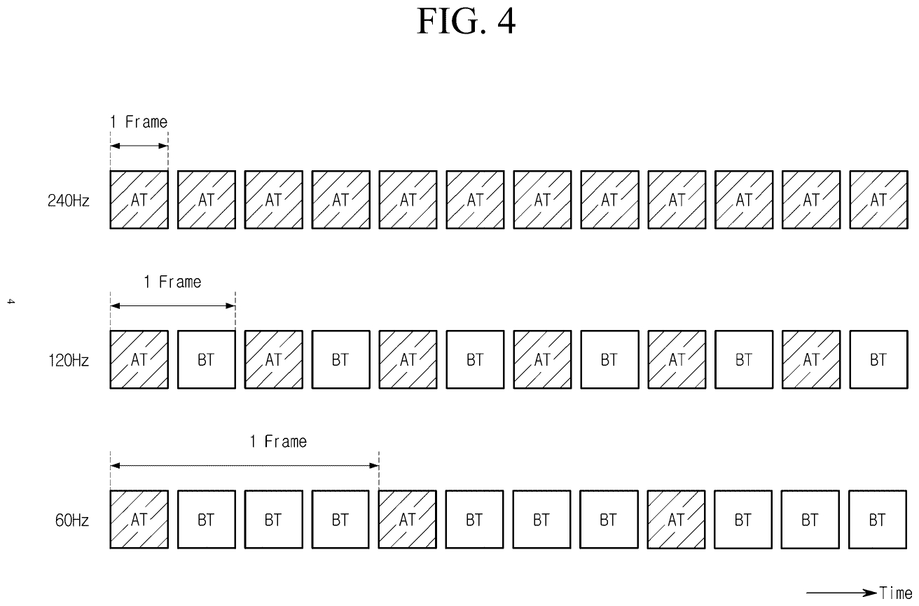

FIG. 4 is a view illustrating a variable refresh rate driving method according to one implementation.

In a variable refresh rate mode, a length of one frame illustrated in FIG. 3 varies. For example, the length of one frame may be varied by varying a length of the active period AT and/or blank period BT within one frame.

As the length of one frame varies, a programming cycle of the data voltage Vdata, for example, a generation cycle of the active period AT, may vary. The generation cycle of the active period AT increases with a lower refresh rate, and a length of the blank period BT between active periods AT increases with a lower refresh rate.

For example, in the illustrated implementation, the generation cycle of the active period AT may be 1 second/240 (1×) at 240 Hz, 1 second/120 (2×) at 120 Hz, and 1 second/60 (4×) at 60 Hz. For example, the length of one frame may be 1× at 240 Hz, 2× at 120 Hz, and 4× at 60 Hz. The length of the blank period BP between two adjacent active periods AT increases according to the length of the frame and the frequency of the active period AT. However, the present implementation is not limited thereto.

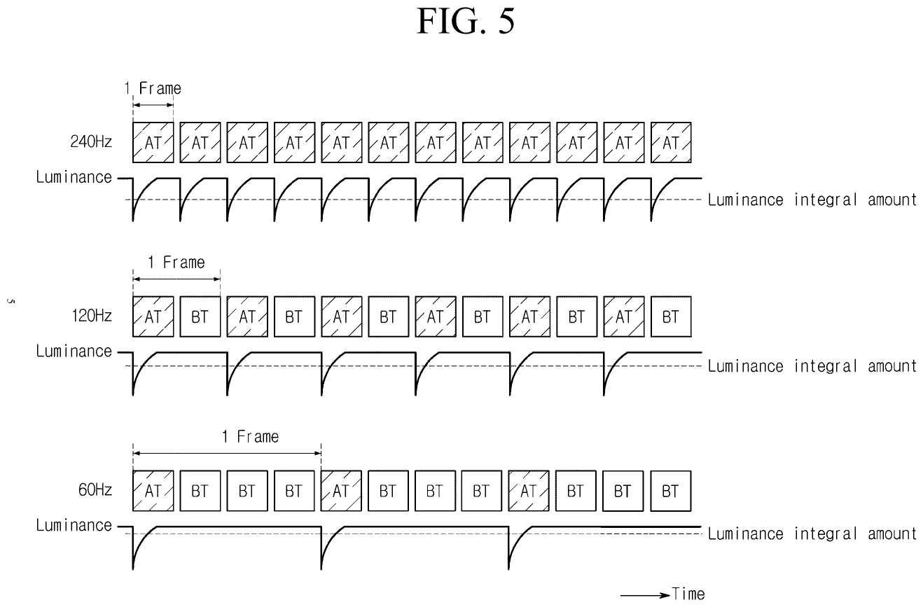

FIG. 5 is a view illustrating a difference in integrated luminances according to refresh rates.

Referring to FIGS. 4 and 5 together, when the length of the blank period BT is increased by variable refresh rate driving, lengths of light emission times t3 and t4 in the corresponding frame increase. Accordingly, upon comparing the integrated luminances for a predetermined time, as the refresh rate (i.e., the longer the blank period BT) decreases, the integrated luminance is relatively higher when the refresh rate is lower (i.e., when the blanki period BT is longer) than when the refresh rate is higher. For example, the integrated luminance for a predetermined time is greater at 120 Hz compared to 240 Hz, and greater at 60 Hz compared to 120 Hz.

The difference in integrated luminances may result in changes in luminance perceived by the user. In particular, changes in luminance can be more easily perceived when the refresh rate varies.

For example, when a driving frequency of the display device 1 varies from a high frequency to a low frequency, the user may perceive a sharp increase in luminance. Conversely, when the driving frequency of the display device 1 varies from a low frequency to a high frequency, the user may perceive a sharp decrease in luminance.

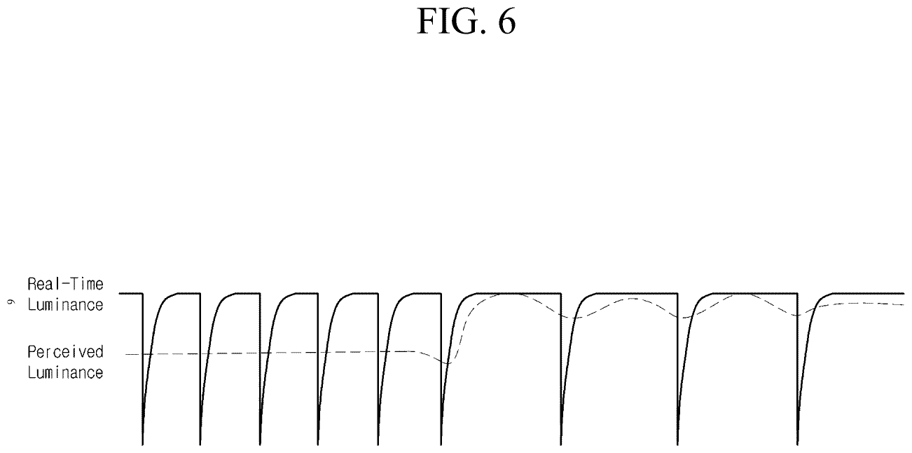

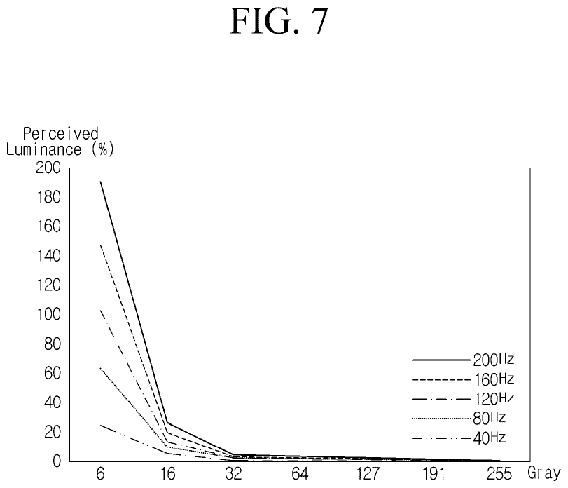

FIG. 6 is a view illustrating a change in perceived luminance according to changes in the refresh rate. FIG. 7 is a view illustrating increases and decreases in perceived luminance according to luminance and refresh rates.

Referring to FIG. 6, as the integrated luminances increase at low frequencies, the perceived luminance perceived by the user increases significantly at low frequencies. Conversely, the perceived luminance perceived by the user decreases relatively at high frequencies. Due to the difference in integrated luminances, flicker may be perceived by the user when the refresh rate changes.

In one implementation, in high-luminance images, since luminance saturation occurs quickly even at high frequencies, the integrated luminance may be relatively great. For example, in high-luminance images, since a difference between the integrated luminances at high and low frequencies is relatively small, flicker may not be perceived by the user.

Conversely, in low-luminance images, since luminance saturation occurs slowly, the difference between the integrated luminances at high and low frequencies increases. Accordingly, in low-luminance images, flicker can be easily perceived by the user when the frequency varies.

As described with reference to FIGS. 5 and 6, the perceived luminance perceived by the user is inversely proportional to the refresh rate and, at the same time, inversely proportional to the luminance of the image (i.e., the original luminance).

Consequently, the perceived luminance is affected by both the luminance and the refresh rate as illustrated in FIG. 7 and is generally inversely proportional to both.

In order to solve such a problem, the display device 1 according to one implementation may be configured to compensate for image data DATA based on a variable refresh rate and the luminance (i.e., the original luminance) of an input image.

Specifically, the display device 1 may compensate for the image data DATA so that the luminance of the displayed image decreases when the refresh rate decreases between adjacent frames, for example, when the driving frequency decreases. And/or, the display device 1 may compensate for the image data DATA so that the luminance of the displayed image increases when the refresh rate increases between adjacent frames, for example, when the driving frequency increases. Accordingly, a difference in perceived luminances before and after the variation of the refresh rate can be reduced, thereby preventing flicker and/or flashing phenomena.

Similarly, the display device 1 may compensate for the image data DATA so that the luminance of the displayed image is further reduced when the luminance of the displayed image is low. Accordingly, it is possible to prevent flicker and/or flashing phenomena from being perceived in low-luminance images when the refresh rate varies.

Hereinafter, the operation of the display device 1 configured in this way will be described in more detail.

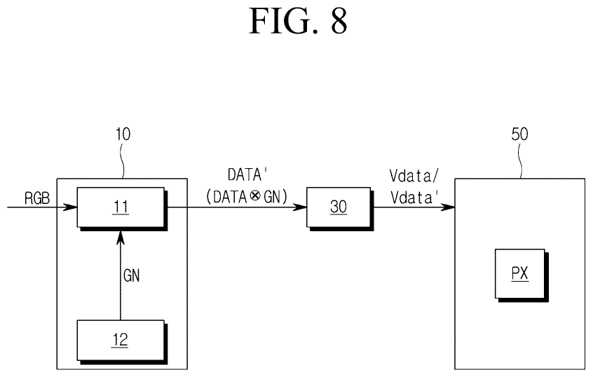

FIG. 8 is a block diagram illustrating a configuration of a timing controller according to one implementation.

Referring to FIG. 8, the timing controller 10 according to one implementation may include an image processor 11 and a storage unit 12.

The image processor 11 receives image signals RGB from an external source, such as a host system. The host system may be, for example, a graphics card, but is not limited thereto.

The host system may generate the image signals RGB and transmit the image signals RGB to the image processor 11. For example, the host system may render predetermined image content appropriately to the operating conditions or the like of the display panel 50, thereby generating the image signals RGB on a frame-by-frame basis.

In one implementation, the time required for rendering may be determined according to the operating environment and performance of the host system, and/or the type and capacity of the image signals RGB and may vary in real time or on a frame-by-frame basis during the operation of the host system. Accordingly, the host system may generate the image signals RGB regularly or irregularly.

The image processor 11 may convert the image signals RGB input from the host system to generate digital image data DATA. The image data DATA may have digital characteristics corresponding to a predetermined luminance value (i.e., an original luminance value) determined by the image signals RGB. The image processor 11 may transmit the generated image data DATA to the data driver 30.

The data driver 30 may convert the digital image data DATA input from the image processor 11 into an analog data voltage Vdata. In addition, the data driver 30 may provide the converted data voltage Vdata to the pixels PX disposed on the display panel 50.

In one implementation, the image signals RGB may be provided to the image processor 11 irregularly depending on changes in a rendering speed, computational load, and the like of the host system.

When the image signals RGB are input from the host system, the image processor 11 generates the image data DATA and transmits the image data DATA to the data driver 30, and the active period AT (see FIG. 3) in which the data voltage Vdata is programmed in the pixels PX through the data driver 30 may be driven.

During the time when the image signals RGB are not input due to the rendering delay, the image processor 11 does not generate the image data DATA, and the data driver 30 does not receive the image data DATA. Accordingly, the blank period BT (see FIG. 3) in which the data voltage Vdata is not programmed in the pixels PX from the data driver 30 may be driven.

As the input cycle of the image signals RGB of the host system varies, the length of the blank period BT (see FIG. 3) may vary In this way, the driving frequency, for example, the refresh rate, of the timing controller 10, the data driver 30, and the display panel 50 may vary depending on the input cycle of the image signals RGB provided from the host system.

In one implementation, the image processor 11 may compensate for the luminance of the image data DATA depending on the input cycle of the image signals RGB, for example, the refresh rate. For example, when the refresh rate decreases, the image processor 11 may decrease the luminance of the image data DATA accordingly. Conversely, when the refresh rate increases, the image processor 11 may increase the luminance of the image data DATA accordingly.

To this end, the image processor 11 may determine a luminance compensation value GN of the image data DATA. The luminance compensation value GN may be defined, for example, as a predetermined gain value for luminance.

In one implementation, the luminance compensation value GN may have a value between 0 and 1. In this implementation, the luminance compensation value GN may represent a reduction percentage with respect to the original luminance of the image data DATA. However, the implementation is not limited thereto.

In one implementation, the luminance compensation value GN may be pre-stored in the storage unit 12. For example, the storage unit 12 may store the luminance compensation value GN corresponding to the refresh rate in the form of a look-up table.

The image processor 11 may determine the refresh rate based on the input cycle of the image signals RGB and select the luminance compensation value GN corresponding to the determined refresh rate from the storage unit 12. In this way, by selecting the preset luminance compensation value GN through the storage unit 12, the computation and luminance compensation time of the image processor 11 can be reduced.

The image processor 11 may apply the selected luminance compensation value GN to the image data DATA to generate compensated image data DATA′. For example, the image processor 11 may generate the compensated image data DATA′ by multiplying the selected luminance compensation value GN by the image data DATA. In addition, the image processor 11 may provide the compensated image data DATA′ to the data driver 30.

The data driver 30 may generate a data voltage Vdata′ based on the compensated image data DATA′. In addition, the data driver 30 provides the compensated data voltage Vdata′ to the pixels PX. Accordingly, the luminance of the image displayed on the pixels PX may be decreased or increased, and when the refresh rate varies, the perceived luminance perceived by the user through the display panel 50 may be adjusted.

In one implementation, the image processor 11 may further compensate for the luminance based on the original luminance values of the image signals RGB and/or the image data DATA. For example, the image processor 11 may further decrease the luminance when the original luminance value decreases (e.g., when the original luminance value is less than a preset threshold value). Conversely, the image processor 11 may maintain the luminance at the original luminance value or further increase the luminance when the original luminance value increases (e.g., when the original luminance value is greater than the preset threshold value).

In this implementation, the storage unit 12 may further store the luminance compensation value GN corresponding to the original luminance value of the image together with the luminance compensation value GN corresponding to the refresh rate in the form of a look-up table.

In one implementation, the luminance compensation value GN corresponding to the refresh rate and the luminance compensation value GN according to the original luminance value of the image may be stored in independent look-up tables. In this case, the image processor 11 may acquire the luminance compensation value GN from two look-up tables corresponding to the determined refresh rate and the original luminance value, respectively. The image processor 11 may apply two luminance compensation value GN to the image data DATA to generate the compensated image data DATA′.

In another implementation, the luminance compensation value GN corresponding to the refresh rate and the luminance compensation value GN according to the original luminance value of the image may be stored in one look-up table. For example, the look-up table may consist of three-dimensional graph data defining the luminance compensation value GN using the refresh rate and the original luminance value as variables. In this case, the image processor 11 may acquire the luminance compensation value GN from the defined one look-up table and apply the luminance compensation value GN to the image data DATA to generate the compensated image data DATA′.

When the look-up table is formed as a single table, a compensation calculation processing speed of the image processor 11 can increase, and processing time can be reduced, enabling efficient and rapid compensation processing and response to variable refresh rates.

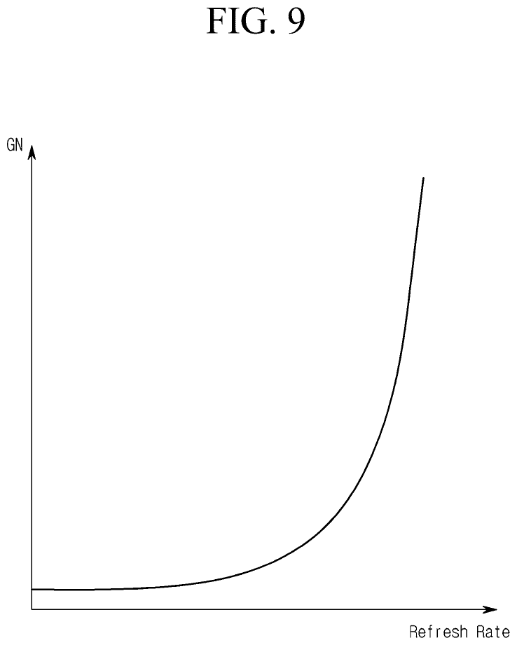

The luminance compensation value GN defined through the look-up table will be described in more detail below with reference to FIGS. 9 to 12.

The data driver 30 may generate a data voltage Vdata′ based on the compensated image data DATA′. In addition, the data driver 30 provides the compensated data voltage Vdata′ to the pixels PX. Accordingly, the luminance of the image displayed on the pixels PX can be decreased or increased, and the perceived luminance difference due to the variable refresh rate in low-luminance images can be relatively less perceived by the user.

Consequently, such luminance compensation can mitigate the luminance unevenness described with reference to FIGS. 6 and 7 and improve image quality degradation caused by flicker and flashing.

FIGS. 9 to 11 are views illustrating luminance compensation values based on luminance and refresh rates according to one implementation.

As described with reference to FIGS. 6 and 7, in variable refresh rate mode, the perceived luminance increases at low frequencies and decreases at high frequencies. In addition, such a difference in perceived luminance increases at low luminances and decreases at high luminances.

In order to improve this luminance deviation, as described with reference to FIG. 8, the timing controller 10 determines the luminance compensation value GN based on the refresh rate and the original luminance value of the image data DATA.

In one implementation, the luminance compensation value GN may be a predetermined gain value and may define a luminance decrease rate and/or luminance increase rate. For example, the luminance compensation value GN may be a value between 0 and 1. In this case, the luminance compensation value GN may be a compensation value for maintaining the original luminance or decreasing the luminance.

However, the implementation is not limited thereto. For example, in various other implementations, the luminance compensation value GN may be set to define a decrease rate and/or increase rate of luminance, which is greater than 1, or to define an increase amount and/or decrease amount.

Referring to FIG. 9, the luminance compensation value GN may be defined to decrease as the refresh rate decreases. In this case, the luminance compensation value GN may be non-linearly proportional to the refresh rate.

In one implementation, the amount of change in the luminance compensation value GN corresponding to the amount of change in the refresh rate may gradually decrease as the refresh rate decreases and gradually increase as the refresh rate increases. In addition, in one implementation, the luminance compensation value GN may generally converge to 0 in a low-frequency range, and the luminance compensation value GN may generally converge to 1 in a high-frequency range.

In the implementation illustrated in this way, the luminance compensation value GN has an exponential function form with respect to the refresh rate. However, the implementation is not limited thereto.

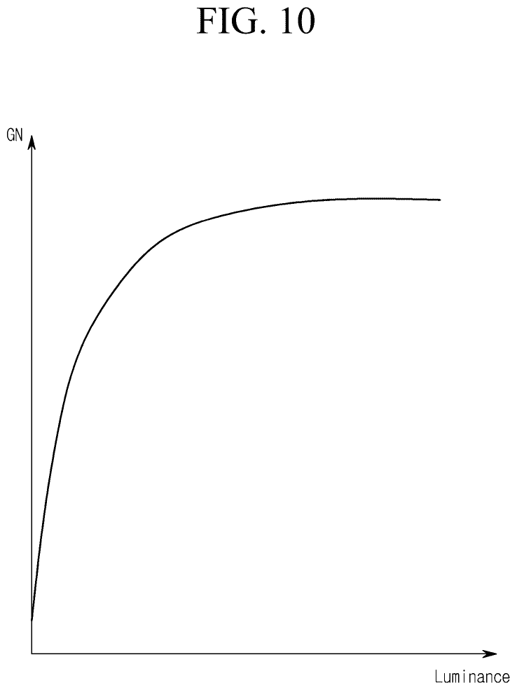

In addition, referring to FIG. 10, the luminance compensation value GN may be defined to decrease as the original luminance value decreases. In this case, the luminance compensation value GN may be non-linearly proportional to the original luminance value.

In one implementation, the amount of change in the luminance compensation value GN corresponding to the amount of change in the luminance value may gradually increase as the luminance value decreases and may also gradually increase as the luminance value increases. In addition, in one implementation, the luminance compensation value GN may generally converge to 0 in a low-grayscale area, and the luminance compensation value GN may generally converge to 1 in a high-grayscale area.

In the implementation illustrated in this way, the luminance compensation value GN has a logarithmic function form with respect to the grayscale value.

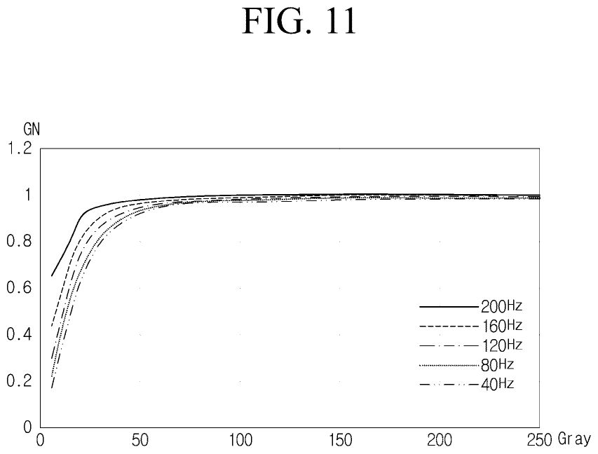

A relationship between the refresh rate and the luminance compensation value GN and a relationship between the luminance value and the luminance compensation value GN, which are illustrated in FIGS. 9 and 10, respectively, are represented by a single graph as shown in FIG. 11. Consequently, this may be represented by a three-dimensional graph of FIG. 11, which defines the luminance compensation value GN according to two conditions, for example, the refresh rate and the luminance value.

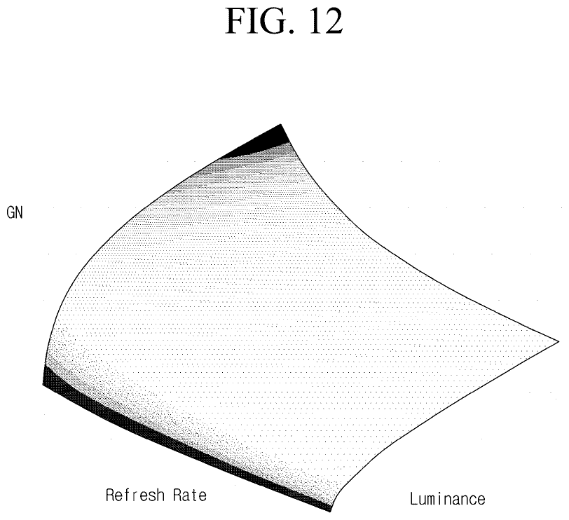

FIG. 12 is a view illustrating luminance compensation values based on luminance and refresh rates according to another implementation.

Compared to the implementation of FIGS. 9 to 11, in the implementation of FIG. 12, the luminance compensation value GN may be defined to increase linearly in response to the luminance value of at least one area. For example, the luminance compensation value GN may increase linearly in proportion to the luminance value when the original luminance value is greater than a first threshold value th1 and smaller than a second threshold value th2.

In this case, the luminance compensation value GN increases linearly between a first compensation value G1 and a second compensation value G2. In one implementation, the second compensation value G2 may be 1, and the first compensation value G1 may be a value between 0 and the second compensation value G2, but the present disclosure is not limited thereto.

When the original luminance value is smaller than the first threshold value th1, the luminance compensation value GN may be set to the first compensation value G1. In addition, when the original luminance value is greater than the first threshold value th2, the luminance compensation value GN may be set to the second compensation value G2.

In FIG. 12, a relationship between the luminance value and the luminance compensation value GN is described as an example, but the luminance compensation value GN may be further defined to increase linearly in response to the refresh rate of at least one area.

According to this implementation, the capacity used to store the luminance compensation value GN in the memory 12 (see FIG. 8) can be reduced, and the processing speed of the image processor 11 (see FIG. 8) can be increased.

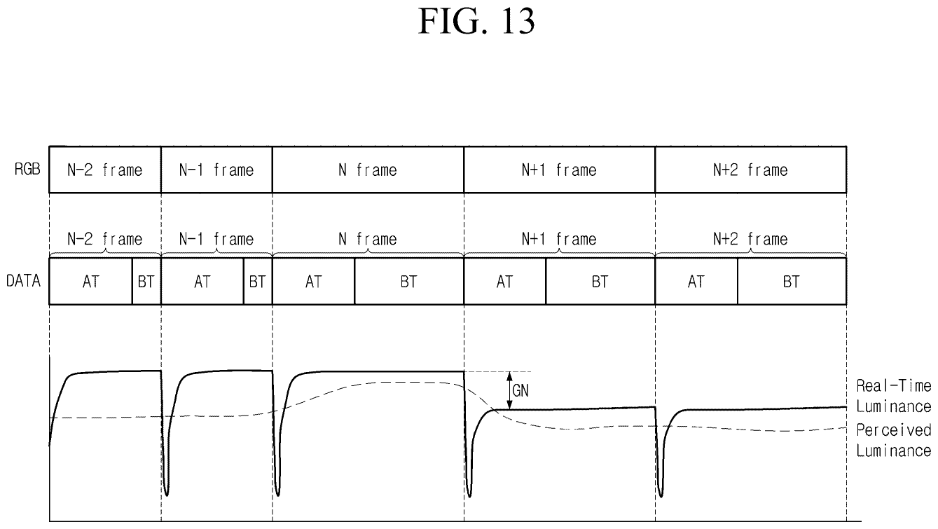

FIG. 13 is a view illustrating input and output signals of an image processor according to one implementation.

Referring to FIGS. 8 and 13 together, the image processor 11 sequentially receives the image signals RGB for each frame from the host system or the like. The input cycle of the image signals RGB may vary irregularly depending on the computational load and rendering speed of the host system. Accordingly, the length of one frame may vary depending on the input cycle of the image signals RGB.

The image processor 11 may process the image signals RGB input on a frame-by-frame basis to generate the image data DATA and output the generated image data DATA. In this case, the image processor 11 may adjust the luminance of the image data DATA according to a refresh rate determined according to an input time point of the image signals RGB.

The output image data DATA is converted into the data voltage Vdata through the data driver 30, and the data voltage Vdata is programmed in the pixels PX during the active period AT of the corresponding frame.

After the active period AT, when the image signals RGB of the next frame are not received, the pixels PX may emit light with the programmed data voltage Vdata during the blank period BT of the corresponding frame.

In this implementation, the length of one frame is determined by the input time point of the image signals RGB of the next frame. For example, the image processor 11 may determine a length of an N^{th} frame and its corresponding refresh rate at the input time point of the image signals RGB of an (N+1)^{th} frame.

Accordingly, even when the length of the N^{th} frame is longer than that of an (N−1)^{th} frame and thus the refresh rate is lower, the image processor 11 may determine that the refresh rate of the N^{th} frame has decreased at the input time point of the image signals RGB of the (N+1)^{th} frame.

In this implementation, the image processor 11 may compensate for the luminance of the image data DATA of the current frame based on the refresh rate of the previous frame. For example, the image processor 11 may compensate for the luminance of the image data DATA of the N^{th} frame based on the refresh rate of the (N−1)^{th} frame and compensate for the luminance of the image data DATA of the (N+1)^{th} frame based on the refresh rate of the N^{th} frame.

In the illustrated implementation, in the N^{th} frame in which actual transition to a low frequency is performed, since the compensation for the decrease in luminance according to the refresh rate is not performed, a temporary increase in perceived luminance may occur.

Then, in the (N+1)^{th} frame, since compensation for the decrease in luminance is performed in response to the decrease in the refresh rate, a difference in luminance compared to a high frequency may be compensated for.

In this case, the rapid change in perceived luminance between the N^{th} frame and the (N+1)^{th} frame may be perceived by the user as flickering, flashing, etc. In order to prevent such phenomena, the image processor 11 may be configured to gradually reduce the luminance in response to the refresh rate. Hereinafter, the above description will be made in more detail.

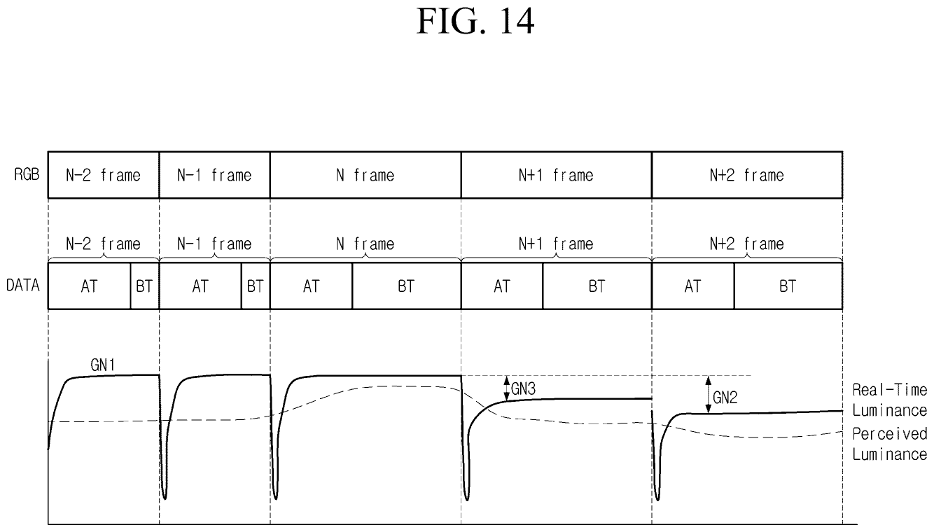

FIG. 14 is a view illustrating input and output signals of an image processor according to another implementation.

Referring to FIGS. 8 and 14 together, the image processor 11 operates to gradually vary the luminance compensation value GN on a frame-by-frame basis when the refresh rate varies between adjacent frames.

For example, in the N^{th} frame, the image processor 11 may compensate for the luminance of the image data DATA based on a first luminance compensation value GN1 corresponding to the first refresh rate of the (N−1)^{th} frame.

When the image signals RGB of the (N+1)^{th} frame are received, the image processor 11 may determine a second refresh rate of the N^{th} frame. In addition, the image processor 11 may determine a second luminance compensation value GN2 corresponding to the second refresh rate.

The image processor 11 may compensate for the luminance of the image data DATA using the second luminance compensation value GN2. In this case, the image processor 11 may compensate for the luminance of the image data DATA based on an arbitrary third luminance compensation value GN3 between the first luminance compensation value GN1 and the second luminance compensation value GN2 during one or more frames. For example, the image processor 11 may compensate for the luminance of the image data DATA based on the luminance compensation value GN3 that gradually varies from the first luminance compensation value GN1) to the second luminance compensation value GN2 during one or more frames starting from the (N+1)^{th} frame.

FIG. 14 illustrates an implementation in which the image processor 11 compensates for luminance using the third luminance compensation value GN3 during one frame and gradually varies the luminance compensation value GN from the first luminance compensation value GN1 to the second luminance compensation value GN2 during two frames. However, the implementation is not limited thereto.

In one implementation, the image processor 11 may gradually compensate for the luminance of image data DATA when the difference in refresh rates between adjacent frames is greater than the preset threshold. In this implementation, the difference in perceived luminance between adjacent frames is reduced compared to the implementation described with reference to FIG. 13. Accordingly, flickering and flashing phenomena due to rapid changes in perceived luminance between adjacent frames can be prevented.

In the display device and the method of driving a display device according to the implementations, it is possible to prevent flicker and flashing phenomena from occurring when the driving frequency is changed in the variable refresh rate mode.

In the display device and the method of driving a display device according to the implementations, it is possible to reduce computation time and computational load by determining the luminance compensation value of the image data within the short time using the look-up table.

In the display device and the method of driving a display device according to the implementations, it is possible to prevent image quality degradation due to luminance fluctuations by compensating luminance step by step over the plurality of frames.

In the display device and the method of driving a display device according to the implementations, it is possible to minimize differences between the perceived integrated luminance and the perceived luminance at low frequencies and those at high frequencies by reducing the perceived integrated luminance and the perceived luminance at low frequencies.

In the display device and the method of driving a display device according to the implementations, it is possible to improve the image quality of low-luminance images in which flicker and flashing phenomena are particularly easily perceived.

Although the implementations of the present disclosure have been described above with reference to the accompanying drawings, those skilled in the art to which the present disclosure pertains will be able to understand that the above-described technical configuration of the present disclosure can be carried out in other specific forms without changing the technical spirit or essential features thereof. Accordingly, it should be understood that the above implementations are illustrative and not restrictive in all aspects. In addition, the scope of the present disclosure is described by the claims to be described below rather than the detailed description. In addition, the meaning and scope of the claims and all changed or modified forms derived from the equivalent concept should be construed as being included in the scope of the present disclosure.

What is claimed is:

1. A display device comprising:
a display panel configured to operate at a driving frequency and on which pixels are disposed;
a gate driving circuit configured to apply a scan signal to the pixels;
a data driving circuit configured to convert image data to generate a data voltage and apply the data voltage to the pixels; and
a timing control circuit configured to receive an image signal from an external source, convert the image signal, and output the image data to the data driving circuit,
wherein the timing control circuit is configured to compensate for a luminance of the image data based on the driving frequency and an original luminance value of the image signal to generate compensated image data and to provide the compensated image data to the data driving circuit.

2. The display device of claim 1, wherein the driving frequency varies depending on a variable refresh rate mode,
wherein in the variable refresh rate mode, the pixels are driven on a frame-by-frame basis, and
wherein each frame includes:
an active period in which the data voltage is programmed in the pixels; and
a blank period in which the programming of the data voltage is omitted and a length of the blank period varies depending on the driving frequency.

3. The display device of claim 1, wherein the timing control circuit includes:
an image processor configured to receive the image signal and convert the image signal to generate the image data; and
a memory configured to store a luminance compensation value corresponding to the driving frequency and the original luminance value of the image signal, and
wherein the image processor is configured to determine the luminance compensation value corresponding to the driving frequency and the original luminance value of the image signal from the memory, and apply the selected luminance compensation value to the image data to generate the compensated image data.

4. The display device of claim 3, wherein the luminance compensation value is configured to:
decrease nonlinearly as the driving frequency decreases; and
decrease nonlinearly as the original luminance value decreases.

5. The display device of claim 3, wherein the memory includes:
a first look-up table comprising a first luminance compensation value corresponding to the driving frequency; and
a second look-up table comprising a second luminance compensation value corresponding to the original luminance value, and
wherein the image processor is configured to generate the image data using the first luminance compensation value acquired from the first look-up table and the second luminance compensation value acquired from the second look-up table.

6. The display device of claim 3, wherein the memory is configured to store a look-up table including a luminance compensation value defined in a three-dimensional graph form using the driving frequency and the original luminance value as variables, and
wherein the image processor is configured to generate the image data using the luminance compensation value acquired from the look-up table.

7. The display device of claim 3, wherein the luminance compensation value comprises:
a first luminance compensation value, based on the driving frequency or the original luminance value being less than a first threshold value;
a second luminance compensation value, based on the driving frequency or the original luminance value being greater than or equal to a second threshold value that is greater than the first threshold value; and
a value that is linearly proportional to the driving frequency or the original luminance value between the first luminance compensation value and the second luminance compensation value, based on the driving frequency or the original luminance value being greater than the first threshold value and smaller than the second threshold value.

8. The display device of claim 3, wherein the luminance compensation value is related to an amount of increase or decrease in the luminance and has a value between 0 and 1.

9. The display device of claim 3, wherein the image processor is configured to determine the luminance compensation value based on a driving frequency of a previous frame and apply the selected luminance compensation value to image data of a current frame to generate the compensated image data of the current frame.

10. The display device of claim 9, wherein the image processor is configured to compensate for the luminance of the image data in incremental steps during one or more frames from the current frame.

11. The display device of claim 10, wherein the image processor is configured to:
generate the compensated image data for the image data of a first frame based on a first luminance compensation value;
generate the compensated image data for the image data of a second frame subsequent to the first frame based on a second luminance compensation value according to the driving frequency and the original luminance value; and
generate the compensated image data during at least one of the first frame and the second frame based on a luminance compensation value between the first luminance compensation value and the second luminance compensation value.

12. A display device comprising:
a display panel configured to operate at a driving frequency and on which pixels are disposed;
a gate driving circuit configured to apply a scan signal to the pixels;
a data driving circuit configured to convert image data to generate a data voltage and apply the data voltage to the pixels; and
a timing control circuit configured to receive an image signal from an external source, convert the image signal, and output the image data to the data driving circuit,
wherein the timing control circuit is configured to compensate for the image data using a luminance compensation value determined based on the driving frequency and an original luminance value of the image signal and to provide the compensated image data to the driving circuit driver, and
wherein the luminance compensation value is configured to decrease, based on at least one of the driving frequency and the original luminance value decreasing.

13. The display device of claim 12, wherein the timing control circuit is configured to select the luminance compensation value based on a driving frequency of a previous frame and apply the selected luminance compensation value to image data of a current frame to generate the compensated image data of the current frame.

14. The display device of claim 13, wherein the timing control circuit is configured to compensate for the luminance of the image data in incremental steps during one or more frames from the current frame.

15. A method of driving a display device including a display panel which is driven at a driving frequency and on which pixels are disposed, a gate driving circuit that applies a scan signal to the pixels, a data driving circuit that converts image data to generate a data voltage and apply the data voltage to the pixels, and a timing control circuit that receives an image signal from an external source, converts the image signal, and outputs the image data to the data driving circuit, the method comprising:
generating, by the timing control circuit, compensated image data for the image data of a first frame based on a first luminance compensation value during the first frame; and
generating, by the timing control circuit, compensated image data for the image data based on a second luminance compensation value corresponding to the driving frequency and the original luminance value of the image signal, based on at least one of the driving frequency and the original luminance value of the image signal changing in a second frame subsequent to the first frame.

16. The method of claim 15, wherein the first luminance compensation value and the second luminance compensation value are configured to decrease, based on at least one of the driving frequency and the original luminance value decreasing.

17. The method of claim 15, wherein the generating of the compensated image data for the image data of the second frame includes:
generating the compensated image data for the image data of a third frame subsequent to the second frame based on the driving frequency of the second frame and the original luminance value.

18. The method of claim 15, further comprising generating compensated image data of the image data based on a third luminance compensation value between the first luminance compensation value and the second luminance compensation value during at least one of the first frame and the second frame.

19. The method of claim 18, wherein the third luminance compensation value is configured to gradually increase or decrease from the first luminance compensation value to the second luminance compensation value during the at least one frame.
